(19) United States
(12) Patent Application Publication
(10) Pub. No.: US 2016/0267436 A1
(43) Pub. Date: Sep. 15, 2016

(54) SYSTEM AND METHOD FOR PROFESSIONAL NETWORKING

(71) Applicant: Purple Squirrel, Inc., San Francisco, CA (US)

(72) Inventors: Jonathan Silber, San Francisco, CA (US); James Christopher Erickson, San Francisco, CA (US)

(21) Appl. No.: 14/864,629

(22) Filed: Sep. 24, 2015

Related U.S. Application Data
(60) Provisional application No. 62/055,479, filed on Sep. 25, 2014.

(51) Int. Cl. G06Q 10/10

(52) U.S. Cl. CPC G06Q 10/1053

(57) ABSTRACT

Described is a technology that provides job seekers a private marketplace to gain access to current employees of companies, who provide access to unlisted job postings, personalized career, interview, or other advice through a professional networking service. On one hand, the technology enables a job seeker to learn about unlisted jobs (e.g., jobs that are not publicized/posted on job boards or not yet formalized for a posting), obtain advice from employee(s) of a company, increase the job seeker's chance of getting hired, and obtain general company information (e.g., cultural fit, negotiation of salary, etc.). On the other hand, the technology enables an employee of a company to receive compensation for their time providing advice to the job seeker and to increase the chances of receiving an employee referral bonus. Further, the technology enables the company to acquire a new employee who has been validated by the employee and to reduce resources and expenses spent on recruitment.

### CROSS-REFERENCE TO RELATED APPLICATION

This application claims the benefit of U.S. Provisional Patent Application No. 62/055,479, entitled, “SYSTEM AND METHOD FOR PROFESSIONAL NETWORKING,” which was filed on Sep. 25, 2015, which is incorporated by reference herein in its entirety.

### BACKGROUND

The current methodologies for hiring and acquiring talent are complex, inefficient, and ineffective for companies and job applicants alike. On average, a company receives approximately 120 applications for a single job posting. Further, only 1-4% of job applicants typically hear back from a company after submitting an application. Certain conventional practices, such as networking, can be helpful for improving the job searching process, but are challenging for most individuals. For example, some individuals are inevitably shy or introverted, do not have extensive networks, or simply do not have the desire to network. While existing job boards attempt to provide a formal mechanism to assist the job search, they provide neither validation of quality applicants for companies nor insights of company culture to applicants.

### BRIEF DESCRIPTION OF THE DRAWINGS

The techniques introduced here may be better understood by referring to the following Detailed Description in conjunction with the accompanying drawings, in which like reference numerals indicate identical or functionally similar elements:

FIG. 1 is a block diagram illustrating an environment in which the disclosed technology can be implemented.

FIG. 2 is a block diagram of components of a server that may be used to execute one or more techniques of the disclosed technology.

FIGS. 3A-3D are flow diagrams of processes for creating a user account and logging into the system.

FIG. 4 is a flow diagram of a process for searching for an employee.

FIGS. 5A-5C are flow diagrams of processes for displaying information associated with user profiles.

FIG. 6 is a flow diagram of a process for scheduling a meeting time with an employee.

FIG. 7 is a flow diagram of a process for generating and transmitting messages.

FIG. 8 is a flow diagram of a process for notification of messages.

FIGS. 9A-9B are flow diagrams of processes for submitting reviews.

FIGS. 10A-10B are flow diagrams of processes for creating employee and company profiles.

FIG. 11 is a block diagram of a computer system as may be used to implement features of some of the embodiments.

While the flow and sequence diagrams presented herein show an organization designed to make them more comprehensible by a human reader, those skilled in the art will appreciate that actual data structures used to store this information may differ from what is shown, in that they, for example, may be organized in a different manner, may contain more or less information than shown, may be compressed and/or encrypted, etc.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the drawings and are described in detail below. The intention, however, is not to limit the particular embodiments described. On the contrary, the embodiments are intended to cover all modifications, equivalents, and alternatives falling within the scope of the disclosed embodiments as defined by the appended claims.

### DETAILED DESCRIPTION

Disclosed is a technology that provides job applicants, or job seekers, a private marketplace to gain access to current employees of companies, and through these employees, unlisted job postings, and personalized interview, career and other advice through an online marketplace where the job seekers can book/schedule appointments to connect with the employees (“the disclosed technology”). On one hand, the disclosed technology enables a job seeker to learn about unlisted jobs (e.g., jobs that are not publicized/posted on job boards or not yet formalized for a posting), obtain interview advice from one or more employee(s) of a prospective company, increase the job seeker's chance of getting hired by the prospective company, and obtain general information about the prospective company (e.g., for evaluation of cultural fit, negotiation of salary, etc.). On the other hand, the disclosed technology enables an employee of a prospective company to receive compensation for providing advice to the job seeker and to provide new opportunities to receiving an employee referral bonus (i.e., if the job seeker gets referred and gets hired). Further, the disclosed technology enables the company to acquire a new employee who has been validated by the employee (e.g., for skills and company cultural fit) and to reduce resources and expenses spent on recruitment (which, in general, do not necessarily have a high return on investment for the company).

According to the disclosed technology, the job search system facilitates a marketplace that matches job seekers with employees based on various factors (e.g., by use of a matching algorithm employing those factors or by use of filters). In some embodiments, a job seeker accesses a job search platform executed by the job search system to search for one or more employee(s) with whom the job seeker desires to consult (i.e., to meet and/or to interview). The job seeker inputs one or more search criteria into the search platform, which, in response, generates a list of one or more employees that match the search criteria. The list of employees is generated for display on a graphical user interface (GUI) to enable the job seeker to select to view more information. The job seeker can also view a fee and/or rate for a consultation with the selected employee (i.e., a “consultation fee”). A particular consultation fee can be by timed session (e.g., a 30-min. session, two 30-min. sessions, etc.) or by hour (e.g., 1 hour total that can be split into various sessions, 2 hours total, etc.), or by any customized arrangement (e.g., by the employee, by the job seeker, and/or both), and may be dynamically changed based on a current demand of a particular employee or company. For example, if an employee is currently selected by 10 different job seekers currently using the professional network service platform, the consultation fee is increased.

In some embodiments, the employee can be alerted during high-demand times, e.g., when a particular role (held by the employee) and/or a particular company (of and/or related to the employee) is highly searched/requested by one or more job seekers. Once a desired employee is found and selected, the job seeker can proceed to schedule an interview time with the selected employee. The professional network service platform can generate a calendar that is dynamically updated for the job seeker (e.g., via inputs by the employee using the employee's device accessing the professional network service platform). Upon reservation of a particular date/time, the professional network service platform causes a notification to be sent to the selected employee that a reservation, or a booking, has been made. The employee then has the option to accept the booking, reject the booking, or message the job seeker to propose an alternative date/time if necessary.

Note that it is contemplated that, by use of the platform, an employee is able to become a part-time recruiter, or take up a more proactive role in the recruiting process, and is not necessarily limited to the role of an employee of a company. For example, any individual of a company, such as a sales representative, a marketing representative, an engineer, a designer, an accountant, etc., can begin recruiting talent by using the platform.

Various examples of the disclosed techniques will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this section.

### Overview

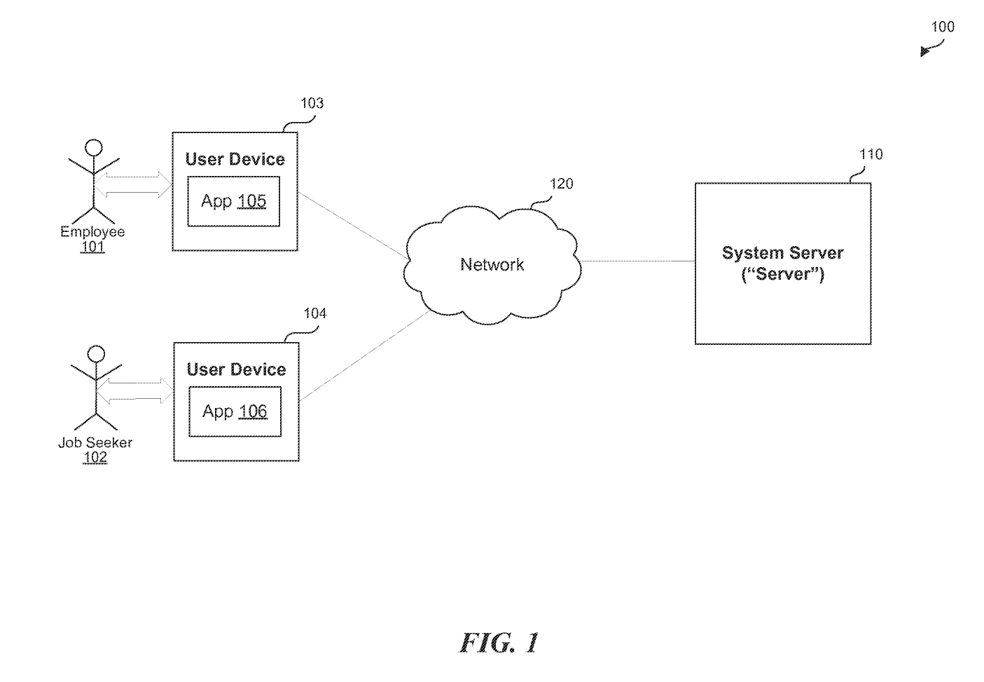

FIG. 1 is a block diagram illustrating an environment 100 in which the disclosed technology can be implemented. The environment 100 includes a first user device 103 belonging to an employee 101 (i.e., a first user), a second user device 104 belonging to a job seeker 102 (i.e., a second user), and a professional networking system server 110 (hereinafter, “server 110”). The user devices 103, 104 can communicate with the server 110 via a network 120, which may be wired or wireless communications network. The server 110 is employed by a professional network service business entity to generate and facilitate a professional network service platform (hereinafter, “platform”) for the first and second users 101, 102. The platform can be a mobile application (e.g., app 105 or app 106) installed on a mobile device, a conventional software application installed on a conventional PC, or a web interface of a website hosted by the server 110.

The employee 101 accesses the platform executed by the server 110 through the second user device 103. In some embodiments, the employee 101 can access the platform through a mobile professional network service application 105 (“app 105”) installed on the second user device 103. In some embodiments, the employee 101 can access the platform through a web interface (e.g., of a website hosted by the server 110) by using a web browsing application installed on the user device 103. The job seeker 102 accesses the platform executed by the server 110 through the first user device 104. In some embodiments, the job seeker 102 can access the platform through a mobile professional network service application 106 (“app 106”) installed on the second user device 104. In some embodiments, the job seeker 102 can access the platform through a web interface (e.g., of a website hosted by the server 110) by using a web browsing application installed on the user device 104.

Through access to the platform, the employee 101 can create a user account and start posting his/her schedule availabilities for consultation with one or more job seekers (e.g., lunch dates and times). The employee 101 creates the user account by providing a validated identifier, which can include, for example, a corporate email address, a validation code, a validated social networking account (e.g., a LinkedIn account, a Facebook account, etc.), etc. Once the user account is created, the server 110 receives information about the company at which the employee 101 works. The employee 101 can input criteria related to prospective interviewees, or desired job seekers, with whom the employee 101 is interested in meeting to discuss information related to the employee's company. The employee 101 can also input criteria related to the industry, job description, job level, and/or specialty of the employee 101 at the company. The various criteria submitted by the employee 101 (“employee criteria”) can be incorporated in the matching algorithm that is used in generating results for the job seeker's search.

In some embodiments, the server 110 uses at least a portion of the employee criteria to recommend a consultation rate for the employee 101 to charge for the meeting time. In some embodiments, the server 110 can recommend a rate, or consultation fee, for the employee 101 based on the experience, background, current salary, and/or job level at the company. In some embodiments, the server 110 can recommend the consultation fee based on the current demand for those experience, background, company and/or job level. For example, the server 110 recommends to the employee 101, who has submitted information of her current job level and position and current salary and that she only has 2 time slots available this week, a consultation fee of $600/hr. In another example, the server 110 recommends a rate of $50/hr. Additionally, employees will have the option to set a percentage of the fees paid to them by job seekers to be donated to a charity of their choice. For example, an employee can designate 10% of their income (from the platform) to be donated to a charity of his/her choice.

Similar to the employee 101, the job seeker 102 can access the platform to search for the employee 101 by creating a user account. The job seeker 102 can create the user account by providing existing login credentials that are associated with another system (e.g., a validated identifier). The login credentials can be, for example, social networking account credentials (e.g., a LinkedIn® account, a Facebook® account, etc.). The job seeker 102 can add links to his social networks in creating the user account (e.g., Facebook®, Twitter®, Pinterest®, Instagram®, etc.). Once the job seeker 102 has a user account, the job seeker 102 can start searching for employees to meet and schedule a consultation meeting (i.e., a “booking”) with a selected employee (e.g., employee 102).

Note that while the employee 101 and the job seeker 102 each submits their identity information to the server 110, the employee remains anonymous unless they choose to disclose their identity. In some embodiments, the user profile of the employee 101 displays only the experience, background, job level and/or any other relevant career information, and does not display identity information (e.g., name, email address, etc.). For example, the user profile of the employee 101 displays “Manager of Mobile Application Engineering Team at Company ABC.” In such example, the title and role of the employee 101 can remain “vague” while the company's claim is clear so that the job seeker 102 is able to know that he/she is truly talking to an employee at his/her desired company. In some embodiments, the user profile of the job seeker 102 displays only the experience, background, interests, and/or any other relevant job search and/or career-related information, and does not display any identity information (e.g., name, email address, etc.). In some embodiments, the employee 102 is not able to search user accounts or profiles of any job seeker using the platform.

In some embodiments, the level of anonymity applied to a user profile on the platform can be adjusted, or configured by a system administrator of the server 110 or the employee 101/job seeker 102 in regards to his/her respective profile. For example, based on the configuration of the level of anonymity, the employee 101 is not able to see the real name and/or any profile information of the job seeker 102 until the job seeker 102 has scheduled a consultation meeting and that the employee has accepted. In some embodiments, anonymity and confidential information of both parties involved (i.e., the employee 101 and the job seeker 102) are maintained by having all communication be facilitated and monitored within the platform. For example, the server 110 monitors communication messages to detect any red flags.

In some embodiments, the server 110 provides a talent solution mechanism that enables an individual (e.g., a human resource (HR) personnel) to search for job seekers (e.g., the job seeker 102). In such embodiments, anonymity of the job seekers are still maintained as the individual (e.g., HR personnel) can only see the skills of matched applicants and send invites to those matched applicants. Only upon an acceptance by the matched applicants can the HR personnel find out more information about them. For example, the server 110 provides to the HR personnel a filtered list of job seekers who are based in California, who have five years of experience, and who have skills X, Y and Z. The talent solution mechanism can be offered, for example, at a premium to the HR personnel (e.g., $5000 subscription).

In some embodiments, the server 110 generates match recommendations for users of the platform. For example, the server 110 analyzes the user profiles and/or criteria submitted by the employee 101 (and current job seekers of the platform), and recommends potential job seekers for the employee 101 to meet. In another example, the server 110 analyzes the user profiles and/or criteria submitted by the job seeker 102 (and current employees of the platform), and recommends potential employees for the job seeker 102 to meet. In some embodiments, the server 110 analyzes the user profiles of the employee 101 and the job seeker 102 to display relevant advertisements to each respective user.

In some embodiments, the server 110 generates and facilitates a premium subscription service (e.g., $30 per month) that allows the employee 101 to reach out (e.g., send a message) to one or more job seekers who have not booked an appointment.

In some embodiments, the server 110 provides a platform for marketing representatives to reach out to individual users of the platform. In such embodiments, the server 110 recommends relevant users to the marketing representatives, who may reach out, for example, by paying a “consultation fee” to meet with the relevant users. The relevant users are those that have user profiles that match with what the marketing representatives have to offer. The relevant users can be the employee 101 and/or the job seeker 102. In some embodiments, the server 110 communicates with third-party advertisers to enable delivery of advertisements to users (e.g., the employee 101 and/or the job seeker 102) of the platform. The advertisements can be customized based on the needs of the users, where the server 110 utilizes profile data and user activities on the platform to deliver appropriate advertisements.

In some embodiments, the server 110 provides a feedback mechanism that enables both the employee 101 and the job seeker 102 to provide feedback to review one another. In such embodiments, the server 110 generates a feedback form that enables quick evaluation provided by the employee 101 to the job seeker 102. The information submitted through the feedback form can be analyzed, tracked, and provided to the job seeker 102. In some embodiments, this can be used to recommend areas of improvement and/or tools for the improvement for the job seeker 102. For example, the server 110 recommends three articles that address the areas of improvement needed by the job seeker 102. In another example, the server 110 recommends two services that would be beneficial to the job seeker 102 (e.g., services offered by local businesses via advertisements). In yet another example, the server 110 recommends three consultants to the job seeker 102 to work with in order to improve his performance.

In some embodiments, the server 110 provides a resume feedback mechanism that enables resumes of the job seeker 102 to be reviewed by one or more resume experts.

### Exemplary Embodiments

FIG. 12 is a block diagram of components of a server 200 that may be used to execute one or more techniques of the disclosed technology. The server 200 can be the server 110 according to some embodiments. The server 200 includes a repository 205, a network interface 210, and an application platform 220 (“app platform 220”). The app platform 220 includes a professional networking service engine 230, a user input receiver 250, and a display output generator 260. In some embodiments, the professional networking service engine 230 includes a registration/login manager 232, a reviews/feedback component 234, a search component 236, a catalog generator 238, a content generator 240, and a scheduler 242.

The repository 205 can be used for storing the criteria submitted by a user of the platform 220 (e.g., the employee 101 or the job seeker 102), users' profiles, and/or for hosting the website and/or application that facilitates the professional networking service. The repository can include, for example, one or more hard drives, a centralized or distributed data cluster, a cloud-storage service provider, or other suitable storage systems suitable for storing digital data.

The network interface 210 can be a networking module that enables the server 110 to mediate data in a network with an entity that is external to the server 200, through any known and/or convenient communications protocol supported by the host and the external entity. The network interface 210 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.,), Bluetooth, a router, an access point, a wireless router, a switch, a multilayer switch, a protocol converter, a gateway, a bridge, bridge router, a hub, a digital media receiver, and/or a repeater.

The user input receiver component 250 can detect or receive a user's selection from a user's device (e.g., device 103 or 104 of FIG. 1) (e.g., via an input device coupled to the device such as a mouse, a keyboard, a touchscreen, an actuatable button, a gesture capturing device, a microphone, or the like). The component 250 is coupled to the professional networking service engine 230 in communicating the user's inputs.

The display output generator component 260 can generate, adjust, modify, replace, or edit the content of graphical user interfaces (e.g., interface of the app 105 or 106 as displayed on the device 103 or 104) of the app platform 220.

Accordingly, the app platform 220 of the server 200 includes the capabilities to provide an effective, convenient and efficient mechanism to allow individuals (e.g., employees and job seekers) to connect with one another. During normal operations, upon receiving inputs from a job-seeker user (or job seeker) to register with the app platform 220 (e.g., via the user input receiver 250), the app platform 220 can employ the registration/login manager 232 of the professional networking service engine 230 to register the job seeker. Similarly, upon receiving inputs from an employee user (or employee) to register with the app platform 220 (e.g., via the user input receiver 250), the app platform 220 can employ the registration/login manager 232 to register the employee. The app platform 220 can further facilitate a search of employees for the job seeker by employing the search component 236, which searches employees that match job-search related criteria submitted by the job seeker (e.g., via the user input receiver 250). The search component 236 works in coordination with the catalog generator component 238, the content generator component 240, and the scheduler 242 to create a set of one or more employees that match with the job-search related criteria of the job seeker. The set of employees is then displayed to the job seeker on a user device (e.g., via the display output generator 260).

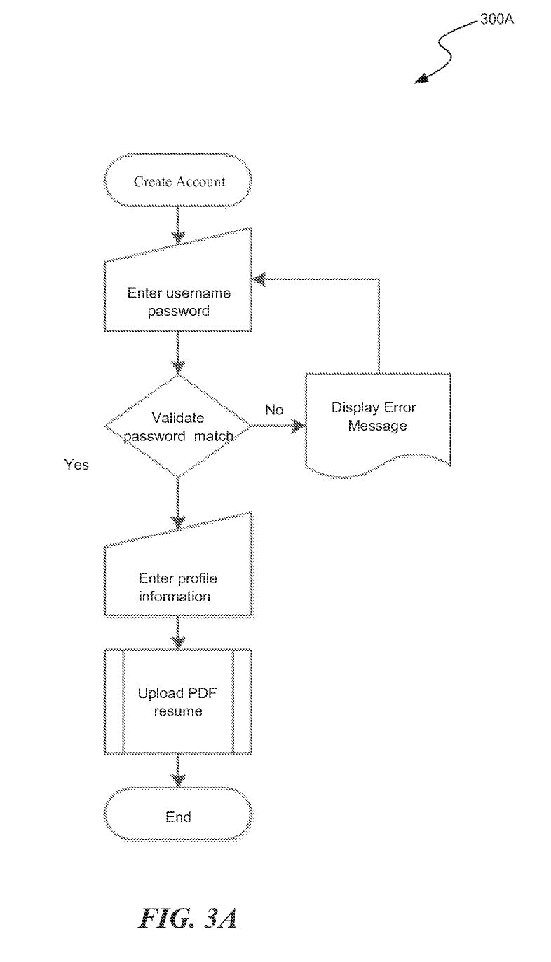

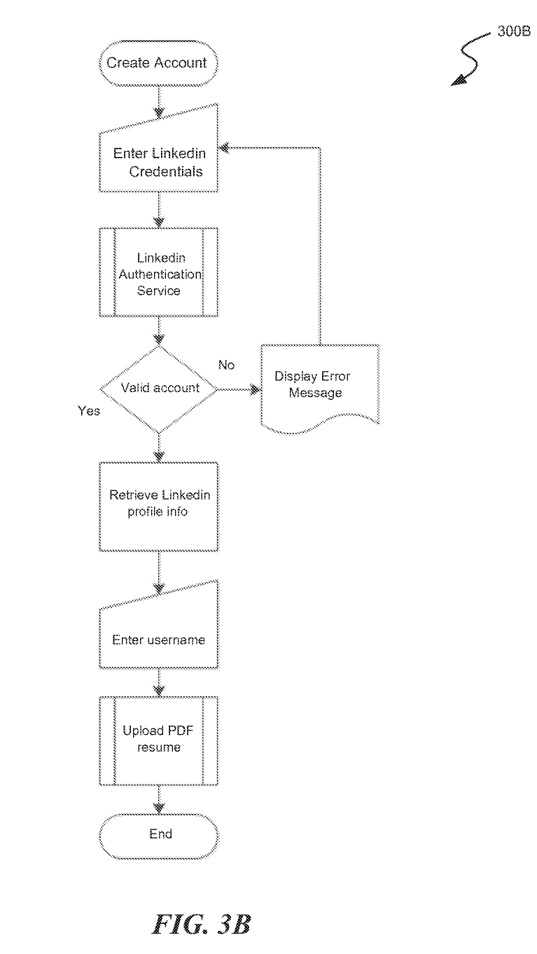

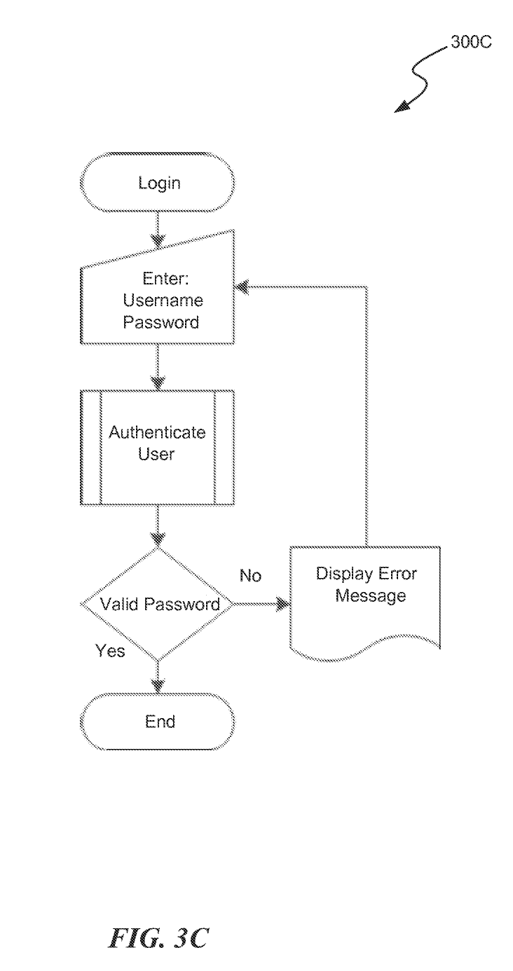

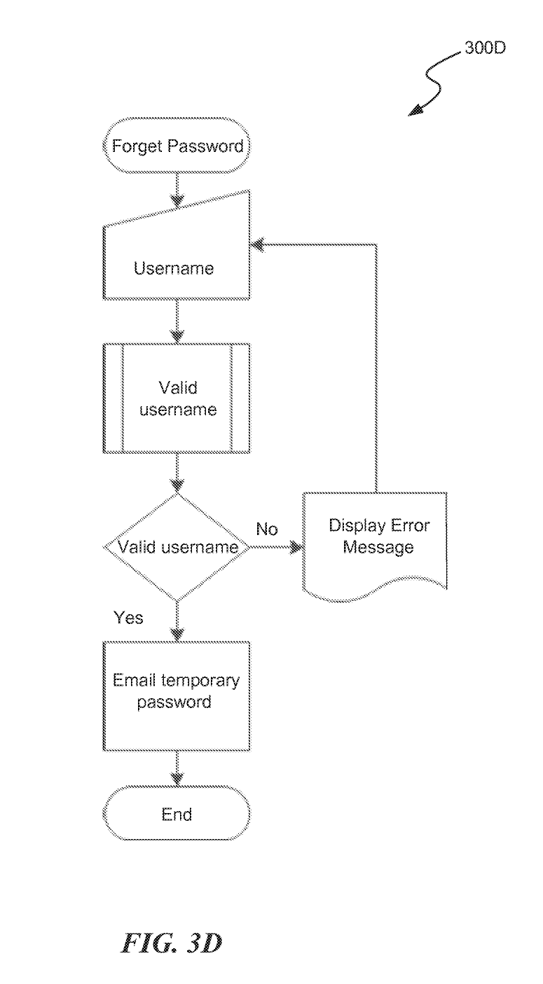

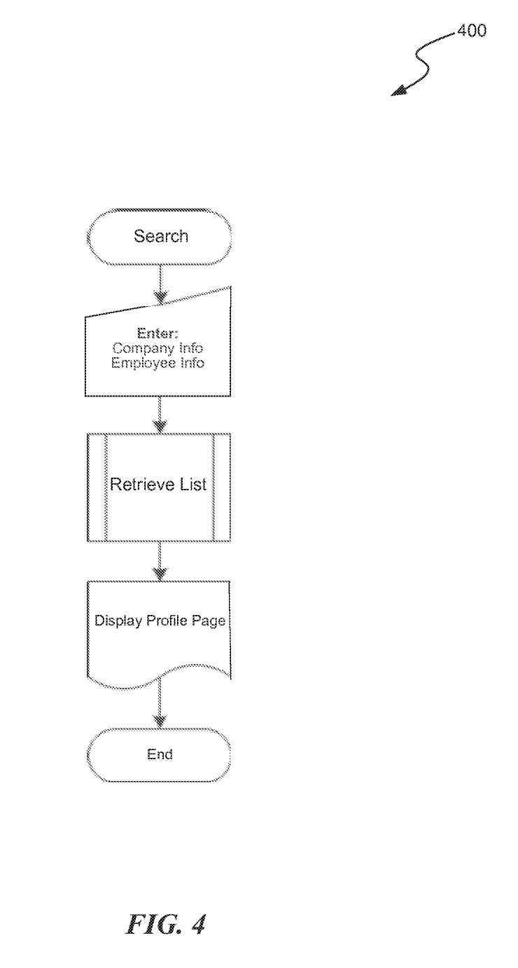

FIGS. 13A-3D are flow diagrams of processes for creating a user account and logging into the system. The user account can be for an employee or a job seeker.

FIG. 3A illustrates a process 300A for creating a user account with the platform. FIG. 3A starts with the user initiating user account creation (e.g., by clicking on an action button “Sign Up” displayed on a graphical user interface (GUI) of the platform (e.g., website). The user enters a username and a password (two times). If the passwords entered twice do not match, an error message is displayed. If there is a match, a new profile page is generated for the user. At that page, the user submits profile information (e.g., skills, interests, etc.). The user can also upload a resume.

FIG. 3B illustrates a process 300B for creating a user account using existing login credentials associated with another service. In the embodiment of FIG. 3B, LinkedIn® credentials are used to create the user account. After the user submits the LinkedIn® credentials, the credentials are forwarded to a computer system server of LinkedIn, which authenticates the credentials to determine whether the user has a valid LinkedIn account. If the account is not valid, an error message is displayed. If the account is valid, the server associated with the platform communicates with the LinkedIn® computer system server to request and retrieve LinkedIn profile information. Next, the user submits a username to be used within the platform. Note that while the LinkedIn information is extracted, the user and/or the system administrator can still control the amount of information displayed to employees in the platform. The user can then upload his resume and start using the platform.

FIG. 3C illustrates a process 300C for logging after a user has registered, where the login process is similar to the process 300A. FIG. 3D illustrates a process 300D for retrieving a forgotten password.

FIG. 14 is a flow diagram of a process for searching for an employee. A registered job-seeker user (or job seeker) can start searching by submitting job-related criteria. The criteria can be about a desired company (e.g., tech company, Google®, HP®, etc.), a desired industry, and/or about a desired expert (e.g., manager-level employee with 10 years of experience in data analytics). Once the job-related criteria, or job-seeker criteria, are submitted, the job seeker can click “Search” and the server retrieves a list of one or more employees that match those criteria. In some embodiments, the employees in the list are ranked based on a matching of criteria associated with the job seeker's search, user profile, and the employees' respective profiles and/or employee criteria. Upon receiving a selection of any employee from the list, a profile page of that employee is displayed for the job seeker (e.g., via the content generator 240). In some embodiments, the job seeker can select one or more employees for a wish list. The wish list may be used in determining a demand of a particular employee (e.g., for recommending a consultation fee). The wish list may be used in the matching algorithm for future searches.

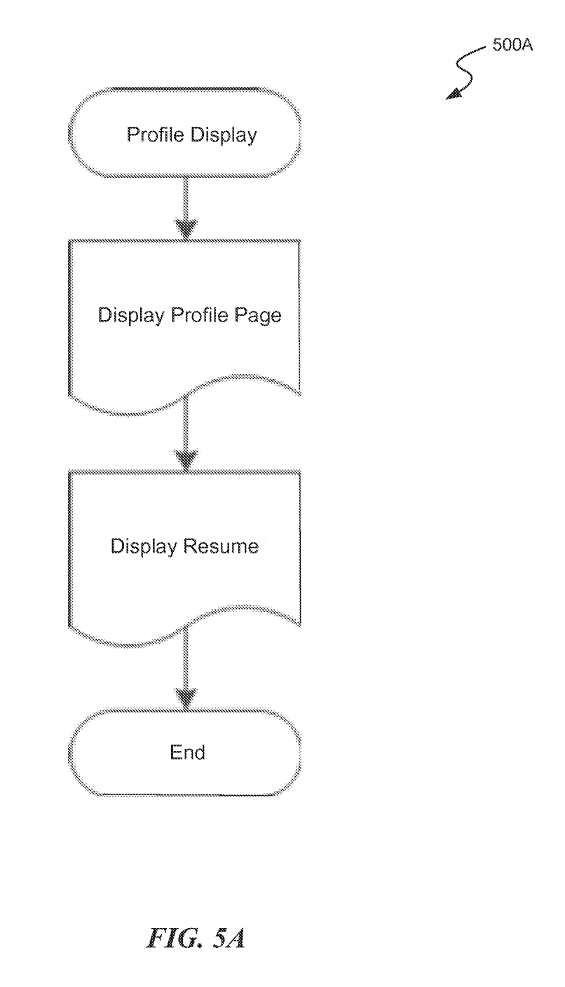

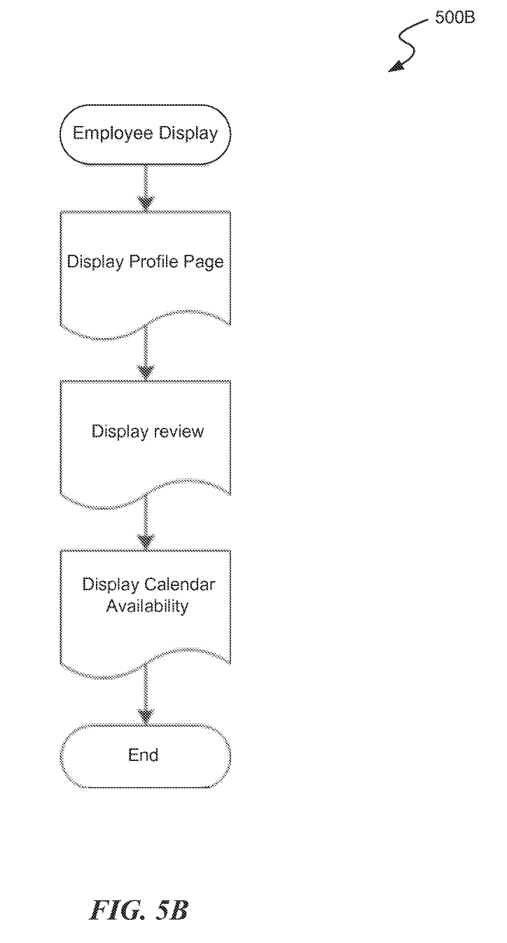

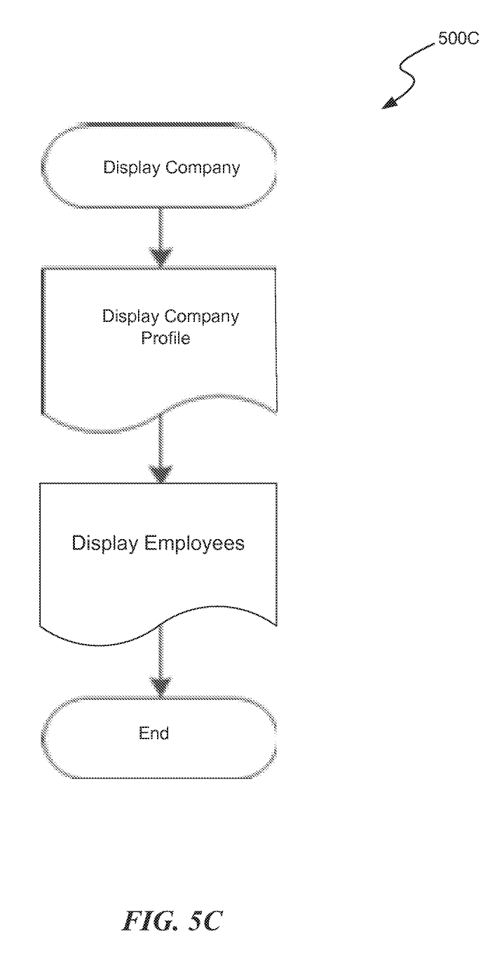

FIGS. 15A-5C are flow diagrams of processes for displaying information associated with user profiles. FIG. 5A illustrates a process 500A for displaying a job seeker's user profile. FIG. 5B illustrates a process 500B for displaying an employee's, or expert's, user profile. FIG. 5C illustrates a process 500C for displaying a company's user profile (e.g., a company displayed on an employee's user profile).

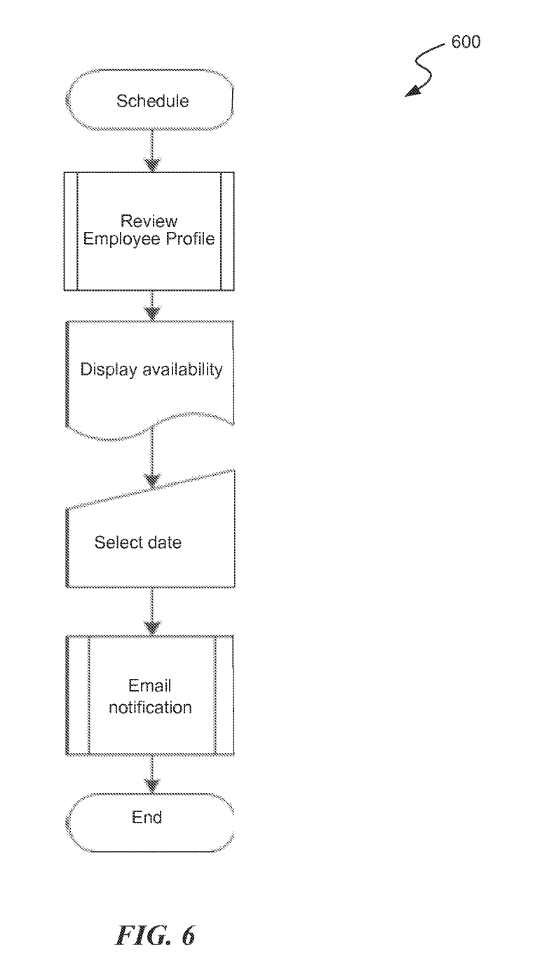

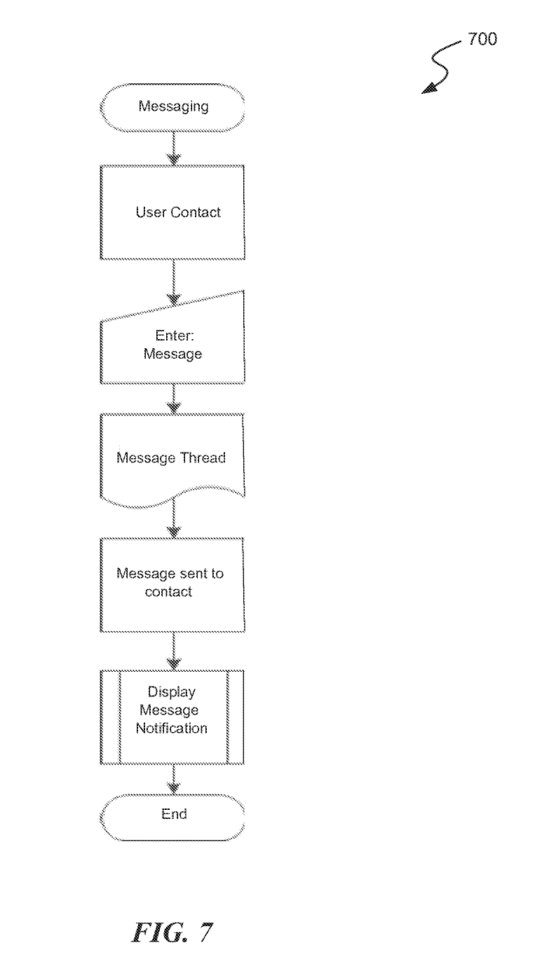

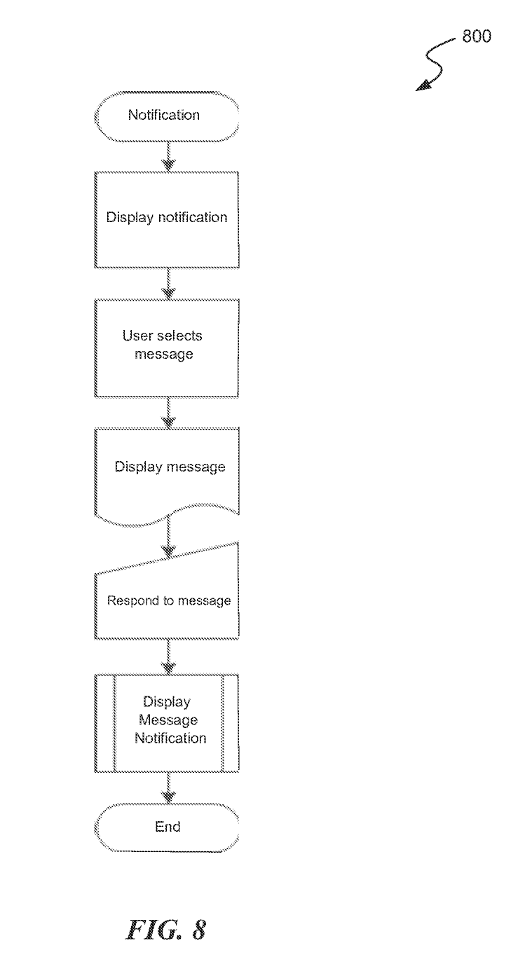

FIG. 16 is a flow diagram of a process 600 for scheduling a meeting time with an employee. FIG. 6 can start when a job seeker selects to schedule a consultation at an employee's user profile user interface. Upon receiving an indication that the job seeker has selected to review the employee's profile, the server displays the availability of that employee. Upon receiving a particular date from the job seeker, the server sends a notification to the employee. In some embodiments, consultation fee is also displayed for each available date of the employee.

FIG. 17 is a flow diagram of a process 700 for generating and transmitting messages. The process can be initiated by a job seeker or an employee who wishes to communicate with another user on the platform. The process starts with a user (e.g., employee or job seeker) selects a user contact. A GUI is generated to prompt the user to submit a message. A message thread is created and the message is sent to the contact, or message recipient. The message recipient receives a message notification in response to the message being sent. In some embodiments, messaging will be limited to users who have scheduled/booked an appointment, or if employees and/or job seekers have paid for a “premium” account that enables them to message job seekers and/or employees before a booking is scheduled.

FIG. 18 is a flow diagram of a process 800 for notification of messages. The process 800 starts when a user sender has generated a message for a user recipient. The server generates and displays for the user recipient a notification. In response to the user recipient selecting the message, the message is displayed. If the user recipient chooses to respond to the message, the server generates a notification to the user sender about the response.

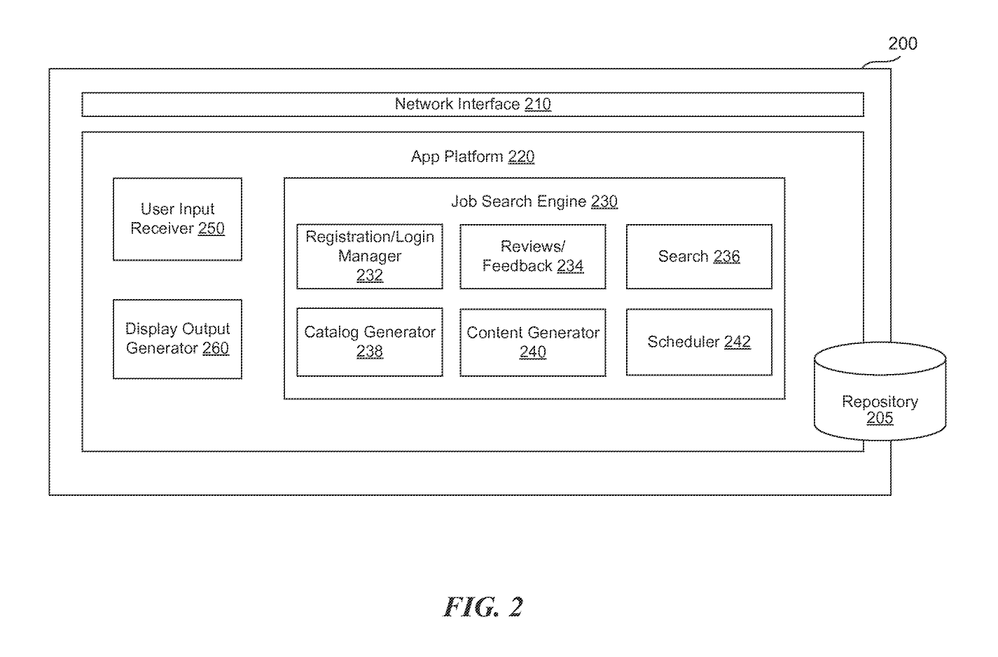

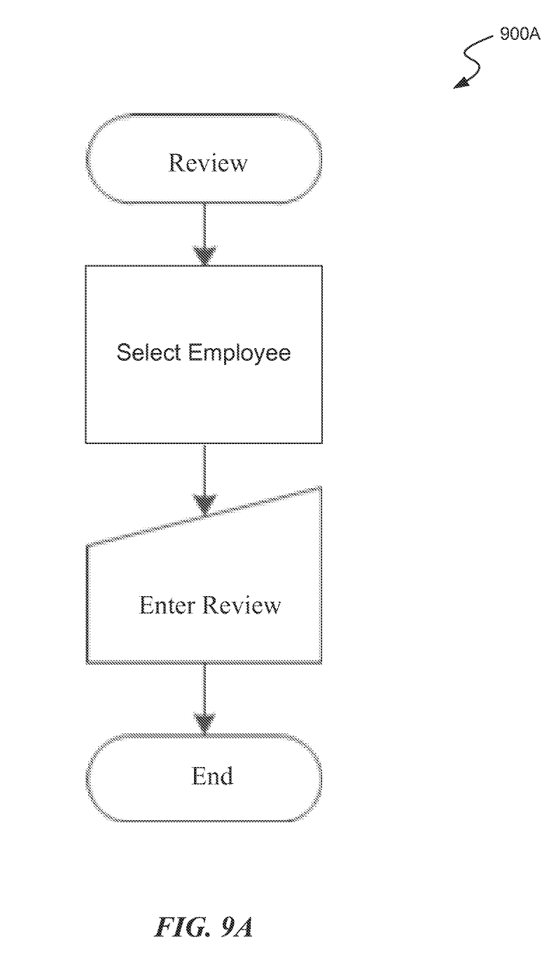

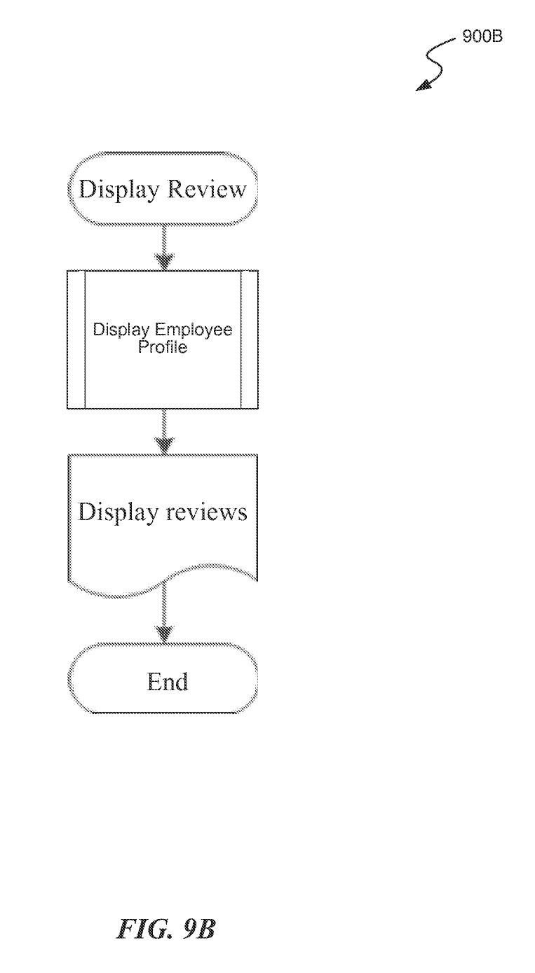

FIGS. 19A-9B are flow diagrams of processes for submitting reviews. FIG. 9A illustrates a process 900A in which a job seeker can select an employee, or expert, and submit a review. The review information is then stored (e.g., in the repository 205 of FIG. 2) by the server for further analysis. The review information can be viewed by the job seeker, another job seeker, the employee, or another employee on the platform. FIG. 9B illustrates a process 900B in which a user selects to view the review.

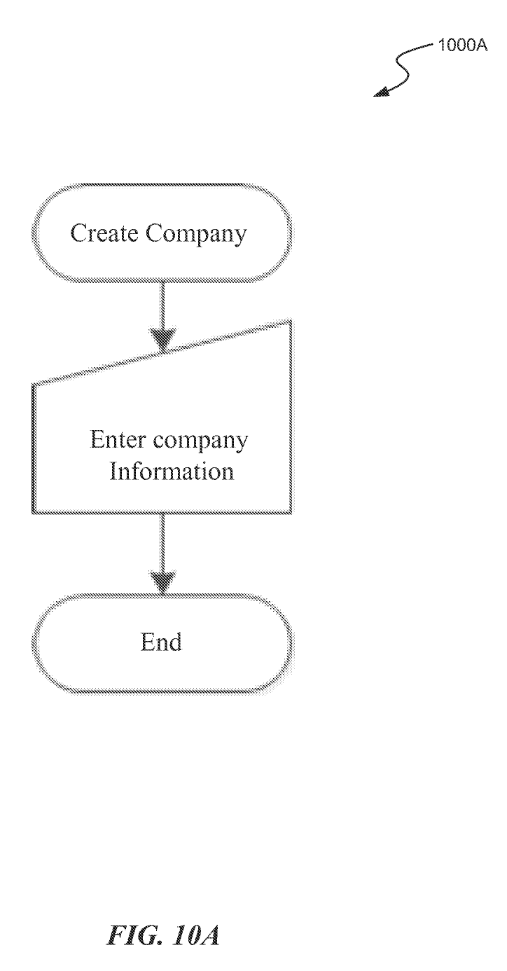

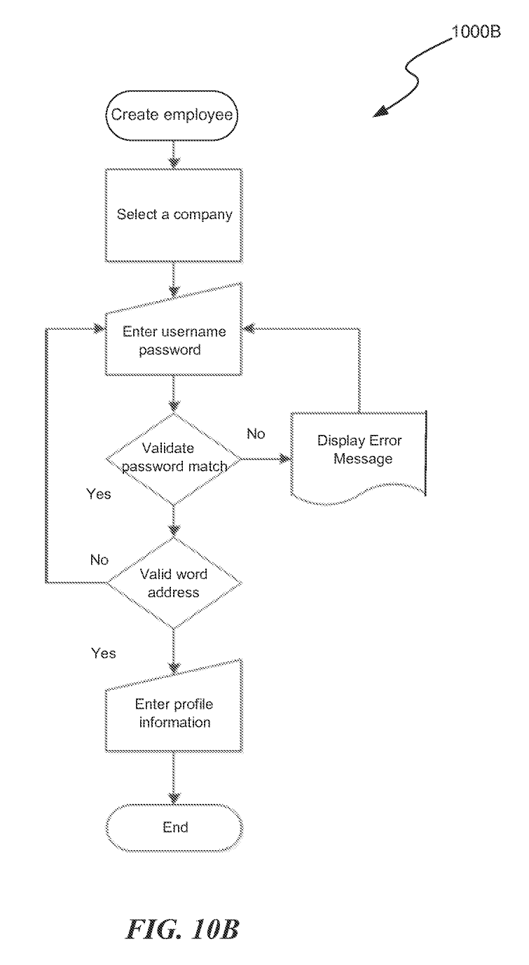

FIGS. 20A-10B are flow diagrams of processes for creating employee and company profiles. FIG. 10A illustrates a process 1000A in which an employee user or a representative of a company (e.g., HR personnel) can create a company profile. FIG. 10B illustrates a process 1000B in which an employee user can create an employee user profile. The employee first selects a company (e.g., a company created in the process 1000A). The employee can then register by submitting a validated identifier, such as a work email address. Upon successful validation of the identifier, the employee is allowed to enter user profile information. In some embodiments, where the identifier fails to validate, the employee user is still allowed to proceed in completing his/her profile. In such embodiments, the employee user's profile remains unlisted in search results and/or inactive until the validation occurs.

### Computer System

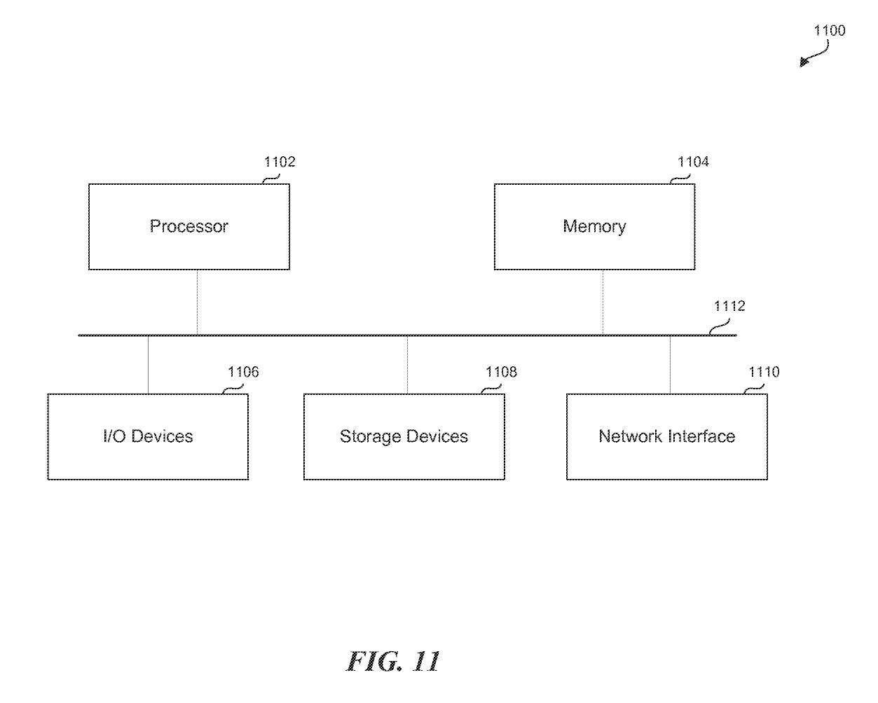

FIG. 11 is a block diagram of a computer system as may be used to implement features of some of the embodiments. The computing system 1100 may include one or more central processing units (“processors”) 1102, memory 1104, input/output devices 1106 (e.g., keyboard and pointing devices, display devices), storage devices 1108 (e.g., disk drives), and network interface 1108 that are connected to an interconnect 1112. The interconnect 1112 is illustrated as an abstraction that represents any one or more separate physical buses, point to point connections, or both connected by appropriate bridges, adapters, or controllers. The interconnect 1112, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1104 and storage devices 1108 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non transitory” media) and computer-readable transmission media.

The instructions stored in memory 1104 can be implemented as software and/or firmware to program the processor(s) 1102 to carry out actions described above. In some embodiments, such software or firmware may be initially provided to the processing system 1100 by downloading it from a remote system through the computing system 1100 (e.g., via network interface 1110).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A computer-implemented method, comprising:
receiving, from a user device of a job-seeker, a first set of criteria, the first set of criteria including one or more criteria associated with profile characteristics of potential employees desired by the job-seeker and one or more criteria associated with profile characteristics of the job-seeker;
receiving, from an employee, a second set of criteria, the second set of criteria including one or more criteria associated with profile characteristics of potential job-seekers desired by the employee and one or more criteria associated with profile characteristics of the employee;
correlating the first and second set of criteria to determine a percentage match between the job-seeker and the employee; and
generating for display to the job-seeker a profile of the employee based on the percentage match.
